(19) United States
(12) Patent Application Publication
(10) Pub. No.: US 2023/0280536 A1
(43) Pub. Date: Sep. 7, 2023

(54) OPTICAL COUPLING DEVICE AND OPTICAL COUPLING SYSTEM

(71) Applicant: NIPPON TELEGRAPH AND TELEPHONE CORPORATION, Tokyo (JP)

(72) Inventors: Tatsuya FUJIMOTO, Musashino-shi, Tokyo (JP); Hidenobu HIROTA, Musashino-shi, Tokyo (JP); Takui UEMATSU, Musashino-shi, Tokyo (JP); Tomohiro KAWANO, Musashino-shi, Tokyo (JP); Hiroyuki IIDA, Musashino-shi, Tokyo (JP); Ryo KOYAMA, Musashino-shi, Tokyo (JP); Tetsuya MANABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/016,438

(22) PCT Filed: Jul. 21, 2020
(86) PCT No.: PCT/JP2020/028203

§ 371 Date: Jan. 16, 2023

(51) Int. Cl. G02B 6/28

(52) U.S. Cl. CPC G02B 6/2821

(57) ABSTRACT

An object of the present disclosure is to provide an optical coupling device capable of controlling a coupling index of optical coupling between two optical fibers for coupling. An optical coupling device of the present disclosure includes two optical fibers for coupling having a core and a clad, and a refractive index variable member to change the refractive index by irradiation with light between the two optical fibers for coupling.

### TECHNICAL FIELD

The present disclosure relates to an optical coupling device and an optical coupling system that perform branching and merging of light using an optical fiber.

### BACKGROUND ART

In services using optical fibers, users have been increasing daily due to the speed of communication. FIG. 1 shows a number of optical cables laid for about 20 years in Japan. Optical cables are laid daily and exceed 1,000,000 kilometers in Japan. The fact that the number of optical cables is significantly extended indicates that the user is more required for services using optical fibers.

In order to provide the service using the optical fiber, a transmission device must be connected to both ends of the optical fiber. An example of the optical access system is shown in FIG. 2. In FIG. 2, reference numeral 11 denotes an optical fiber (#1), reference numeral 51 denotes a user's home (#1), reference numeral 53 denotes a communication building, reference numeral 54 denotes an OLT (Optical Line Terminal), and reference numeral 55 denotes an ONU (Optical Network Unit) (#1).

The OLT 54 is installed in the communication building 53, the ONU (#1) 55 is installed in the user's home (#1), OLT 54 and ONU (#1) 55 are communicated via the optical fiber (#1) 11, and the services using the optical fiber are provided.

Further, when new user desire services using an optical fiber, it is necessary to lay a new optical fiber. FIG. 3 shows an example of laying a new optical fiber. In FIG. 3, reference numeral 11 denotes an optical fiber (#1), reference numeral 12 denotes an optical fiber (#2), reference numeral 51 denotes a user's home (#1), reference numeral 52 denotes a user's home (#2), reference numeral 53 denotes a communication building, reference numeral 54 denotes an OLT, reference numeral 55 denotes an ONU (#1), and reference numeral 56 denotes an ONU (#2).

A new service using an optical fiber has been provided by newly installing the ONU (#2) 56 in the user's home (#2) 52 and connecting the OLT 54 and the ONU (#2) 56 by the optical fiber (#2) 12.

Conventionally, when users desire services using an optical fiber, as shown in FIG. 3, it is necessary to perform a new optical fiber (#2) 12 laying construction between the communication building 53 and the user's home (#2) 52. On the other hand, in a situation where the number of workers is reduced, there is a possibility that the optical fiber laying construction is delayed.

In order to solve this problem, by processing the optical fiber at a construction site, a period of the laying construction of the optical fiber can be shortened. FIGS. 4A and 4B show examples of fabrication of an optical coupler obtained by processing an optical fiber. In FIG. 4A and FIG. 4B, reference numeral 11 denotes the optical fiber (#1), reference numeral 12 denotes the optical fiber (#2), reference numeral 41 denotes a core (#1), reference numeral 42 denotes a core (#2), reference numeral 43 denotes a clad (#1), reference numeral 44 denotes a clad (#2), and reference numeral 57 denotes an optical coupler.

As shown in FIG. 4A, the optical fiber (#1) 11 and the optical fiber (#2) 12 are arranged in parallel, and as shown in FIG. 4B, a region surrounded by broken lines of the optical fiber (#1) 11 and the optical fiber (#2) 12 is melted (see NPL1 and NPL2). When the optical fiber is melted, the core (#1) 41 of the optical fiber (#1) 11 and the core (#2) 42 of the optical fiber (#2) 12 are close to each other, so that optical coupling is generated between the optical fiber (#1) 11 and the optical fiber (#2) 12. The light from the optical fiber (#1) 11 can be branched to the optical fiber (#2) 12 and the light from the optical fiber (#2) 12 is merged to the optical fiber (#1) 11.

If the optical coupler can be manufactured at the construction site, the construction can be quickened. FIG. 5 shows an example of an optical access system using an optical coupler. In FIG. 5, reference numeral 11 denotes the optical fiber (#1), reference numeral 12 denotes the optical fiber (#2), reference numeral 51 denotes the user's home (#1), reference numeral 52 denotes the user's home (#2), reference numeral 53 denotes the communication building, reference numeral 54 denotes the OLT, reference numeral 55 denotes the ONU (#1), reference numeral 56 denotes the ONU (#2), and reference numeral 57 denotes the optical coupler.

A new service using the optical fiber can be provided by newly installing the ONU (#2) 56 in the user's home (#2) 52 and connecting the OLT 54 and the ONU (#2) 56 by the optical fiber (#1) 11, the optical coupler 57, and the optical fiber (#2) 12. The OLT 54, the ONU (#1) 55, and the ONU (#2) 56 are exemplified as a transmission device of a PON (Passive Optical Network).

Conventionally, when users desire services using an optical fiber, as shown in FIG. 3, it has been necessary to newly perform a laying construction of the optical fiber (#2) 12 between the communication building 53 and the user's home (#2) 52. If the optical coupler 57 can be manufactured at the construction site, the optical fiber (#1) 11 from the communication building 53 to the optical coupler 57 can be used in common, so that the construction period can be shortened.

### CITATION LIST

### Non Patent Literature

[NPL 1] https://www.fiberlabs.co.jp/tech-explan/about-fiber-coupler/, “Principle and usage of fiber coupler”
[NPL 2] https://sei.co.jp/technology/tr/bn179/pdf/sei10675.pdf, “Passive Optical Components and Their Application to FTTH Networks”, Hiroo Kanamori

### SUMMARY OF INVENTION

### Technical Problem

However, since the optical coupler shown in FIG. 4B is manufactured by melting the optical fibers, the two optical fibers are completely welded and the two optical fibers cannot be separated again. In order to melt the optical fiber, a fire power exceeding 1000 degrees is required, and an execution at the construction site is unfeasible from the viewpoint of safety. In addition, the manufacturing the accurate optical coupler in the construction site has a problem for quality.

Therefore, the present disclosure is directed to provide an optical coupling device capable of controlling a coupling index of optical coupling between two optical fibers for coupling.

### Solution to Problem

To achieve the above object, the optical coupling device according to the present disclosure is configured to include a refractive index variable member between two optical fibers.

Specifically, an optical coupling device according to the present disclosure includes
two optical fibers for coupling having a core and a clad, and
a refractive index variable member whose refractive index is changed by irradiation of light between two optical fibers for coupling.

Specifically, an optical coupling system according to the present disclosure includes
the optical coupling device of the present disclosure, and
a refractive index control device for irradiating the refractive index variable member with light through the irradiation optical fiber.

### Advantageous Effects of Invention

According to the present disclosure, it is possible to provide the optical coupling device capable of controlling the degree of coupling of optical coupling between two optical fibers for coupling. Further, the optical coupling system utilizing the optical coupling device can be provided.

### BRIEF DESCRIPTION OF DRAWINGS

FIG. 1 is a diagram illustrating a number of optical cables laid.

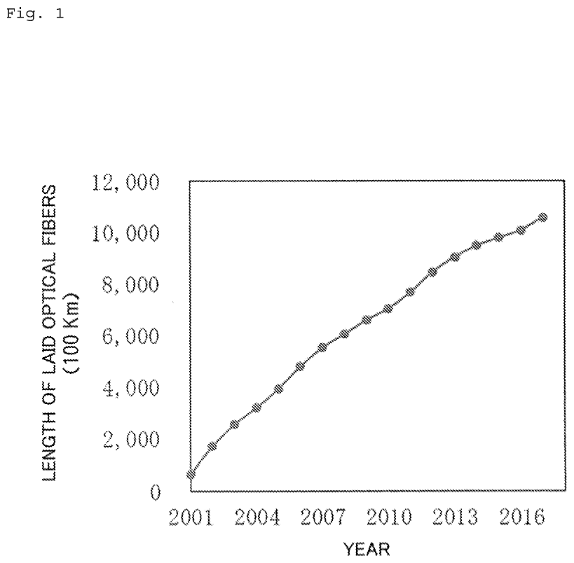

FIG. 2 is a diagram illustrating an example of the optical access system.

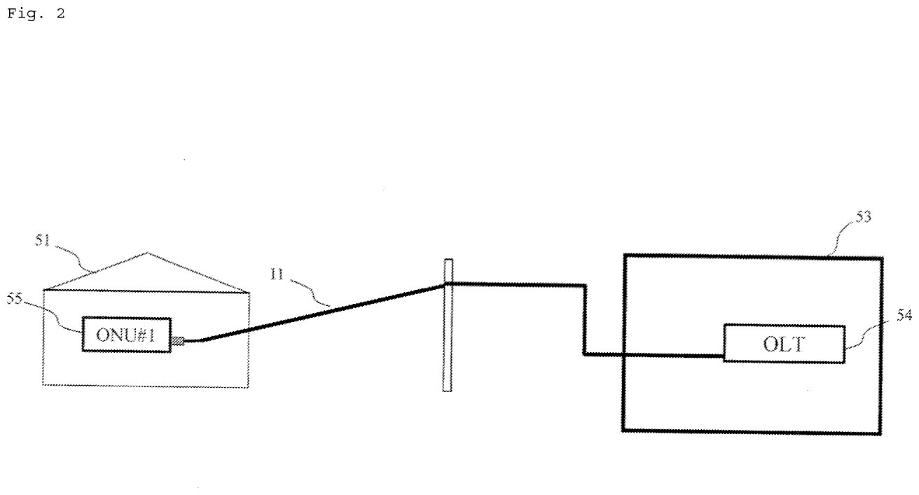

FIG. 3 is a diagram illustrating an example in which a new optical fiber is laid.

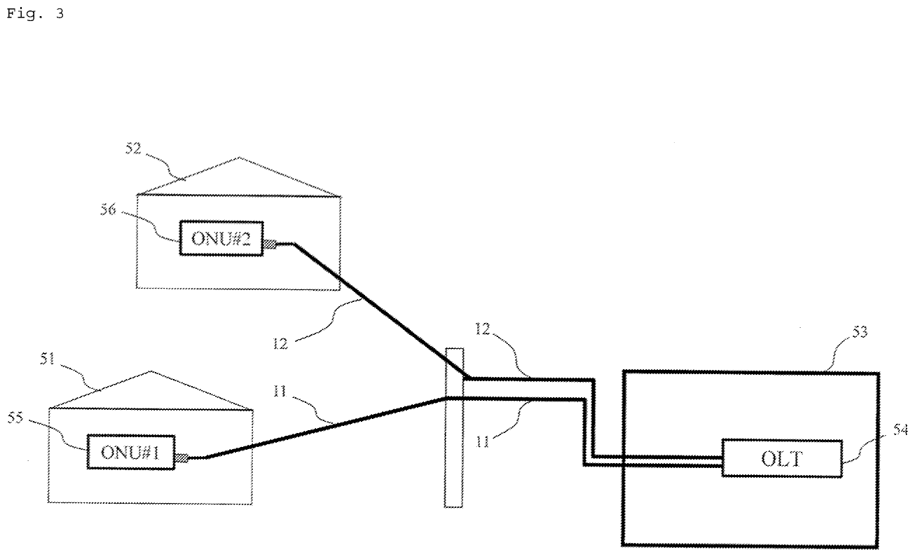

FIG. 4A is a diagram illustrating an example of an optical coupler fabricated from optical fibers.

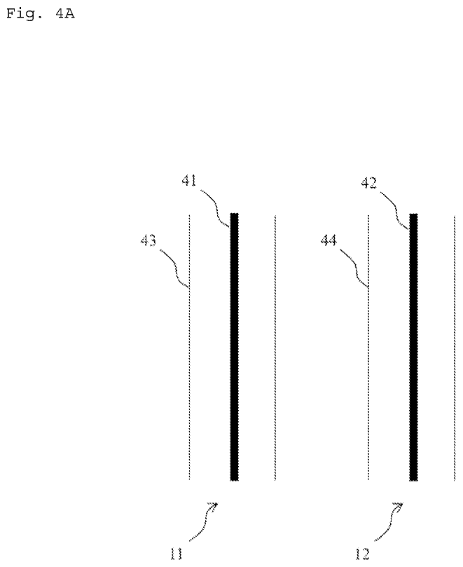

FIG. 4B is a diagram illustrating an example of an optical coupler fabricated from the optical fibers.

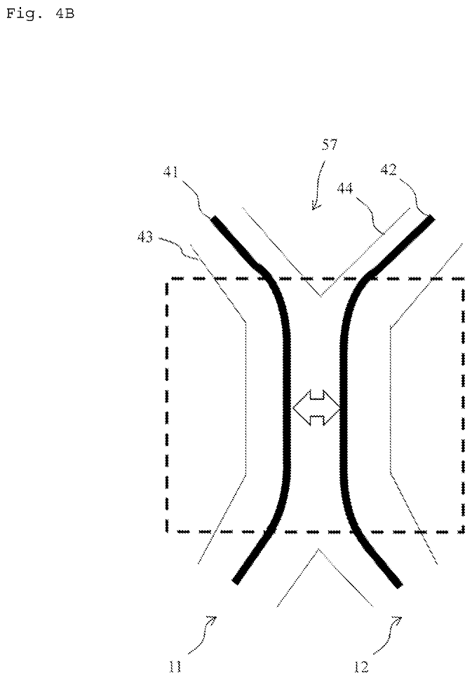

FIG. 5 is a diagram illustrating an example of the optical access system.

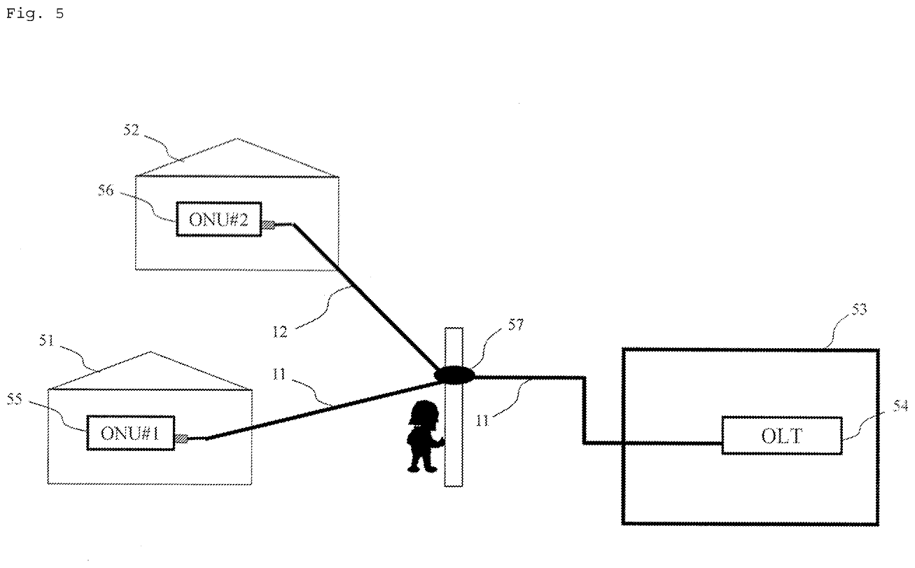

FIG. 6A is a diagram illustrating a specific configuration of the optical coupling device of the present disclosure.

FIG. 6B is a diagram illustrating a specific configuration of the optical coupling device of the present disclosure.

FIG. 7A is a diagram illustrating a specific configuration of the optical coupling device of the present disclosure.

FIG. 7B is a diagram illustrating a specific configuration of the optical coupling device of the present disclosure.

FIG. 8 is a diagram illustrating changes in optical coupling of the optical coupling device of the present disclosure.

FIG. 9 is a diagram illustrating a specific configuration of the optical coupling device of the present disclosure.

FIG. 10 is a diagram illustrating a specific configuration of the optical coupling device of the present disclosure.

FIG. 11 is a diagram illustrating a specific configuration of the optical coupling device of the present disclosure.

FIG. 12 is a diagram illustrating an exterior example of the optical coupling device of the present disclosure.

FIG. 13 is a diagram illustrating a configuration of the optical coupling system of the present disclosure.

FIG. 14 is a diagram illustrating the optical coupling system of the present disclosure.

FIG. 15 is a diagram illustrating the optical coupling system of the present disclosure.

FIG. 16 is a diagram illustrating the optical coupling system of the present disclosure.

FIG. 17 is a diagram illustrating a configuration of the optical coupling system of the present disclosure.

### DESCRIPTION OF EMBODIMENTS

An embodiment of the present disclosure will be described in detail below with reference to the drawings. The present disclosure is not limited to the embodiment described below. The embodiment is merely illustrative, and the present disclosure can be implemented with a variety of modifications and improvements made thereto on the basis of the knowledge of a person skilled in the art. Note that the elements designated by the same reference numerals in the description and the drawings refer to the same elements.

### Embodiment 1

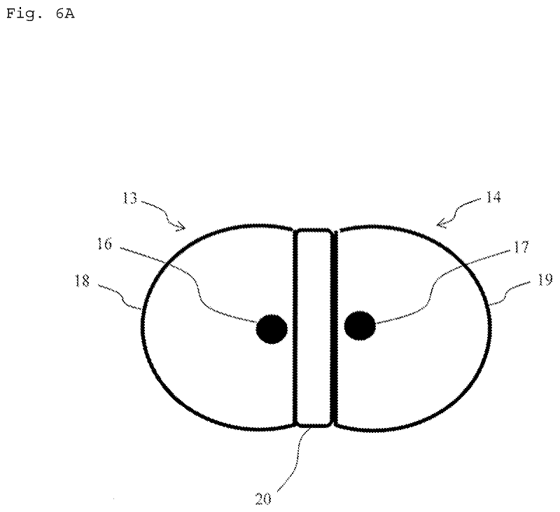

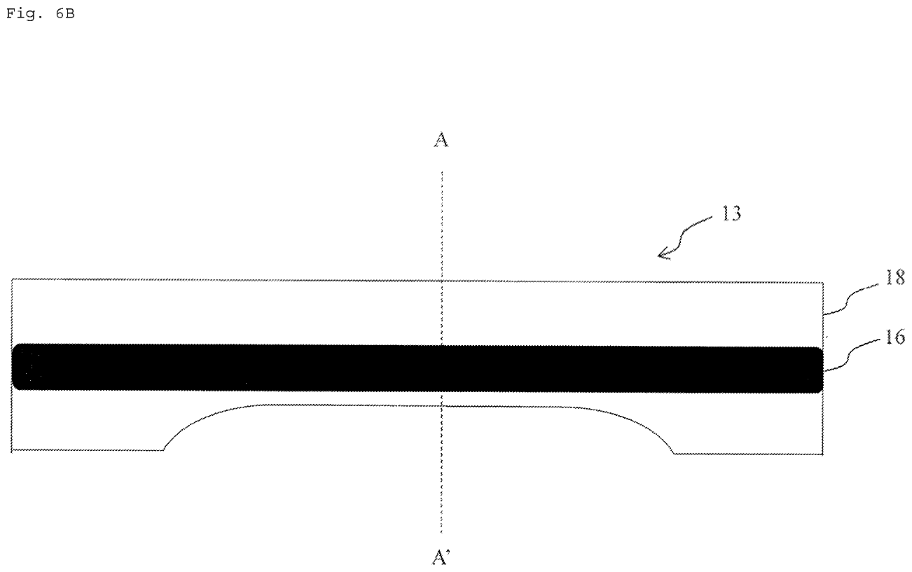

A specific configuration of the optical coupling device of the present disclosure will be described with reference to FIGS. 6A and 6B. In FIG. 6A and FIG. 6B, reference numeral 13 denotes an optical fiber (#3), reference numeral 14 denotes an optical fiber (#4), reference numeral 16 denotes a core (#3), reference numeral 17 denotes a core (#4), reference numeral 18 denotes a clad (#3), reference numeral 19 denotes a clad (#4), reference numeral 20 denotes a refractive index variable member. FIG. 6B is a cross-section in the longitudinal direction of the optical fiber (#3) 13 and a cross-section vertical to the longitudinal direction at A-A′ line of FIG. 6B represents the optical fiber (#3) 13 of FIG. 6A.

For the optical fiber (#3) 13 for coupling used in the optical coupling device of the present disclosure, as shown in FIGS. 6A and 6B, it is desirable that the surface of the clad (#3) 18 of the portion in contact with the refractive index variable member 20 is processed into a planar shape. The same applies to the optical fiber (#4) 14 for coupling. As shown in FIG. 6A, both the optical fiber (#3) 13 and the optical fiber (#4) 14 are called D-type because the cross-sectional shape at the surface vertical to the longitudinal direction is a D shape. Regions processed into the planar shape of two optical fibers machined into the D-type of optical fiber (#3) 13 and optical fiber (#4) 14 are arranged so as to face each other. A refractive index variable member 20 whose refractive index is changed by irradiation of light is arranged between these regions facing each other.

By processing into the D-type, the interval between the core (#3) 16 and the core (#4) 17 is close to each other, and optical coupling is facilitated. Further, by processing the clad (#3) 18 and the clad (#4) 19 into the planar shape, the refractive index variable member 20 can be stably held between the optical fiber (#3) 13 and the optical fiber (#4) 14.

In the optical coupling device shown in FIG. 6A, by irradiating the refractive index variable member 20 with light, the refractive index of the refractive index variable member 20 is changed, and the coupling degree of the optical coupling between two optical fibers for coupling of the optical fiber (#3) 13 and the optical fiber (#4) 14 can be controlled. When the degree of coupling of optical coupling is changed, the branching ratio from the optical fiber (#3) 13 to the optical fiber (#4) 14, or the branching ratio from the optical fiber (#4) 14 to the optical fiber (#3) 13 is changed.

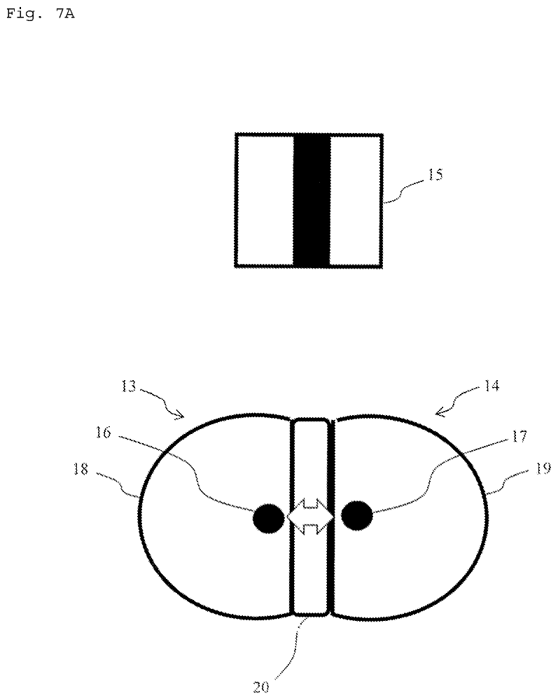

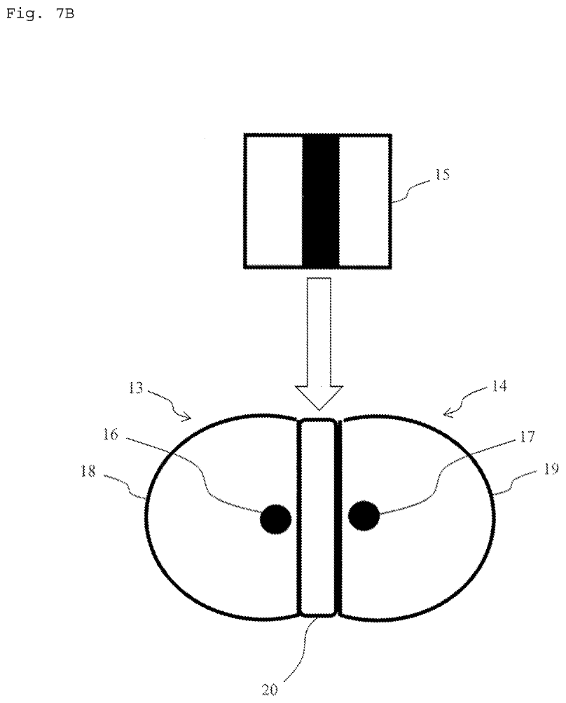

It is desirable that the optical coupling device of the present disclosure further includes an optical fiber for irradiation for irradiating the refractive index variable member with light. A specific configuration of the optical coupling device of the present disclosure will be described with reference to FIGS. 7A and 7B. Reference numeral 13 denotes the optical fiber (#3), reference numeral 14 denotes the optical fiber (#4), reference numeral 15 denotes the optical fiber for irradiation (#5), reference numeral 16 denotes the core (#3), reference numeral 17 denotes the core (#4), reference numeral 18 denotes the clad (#3), reference numeral 19 denotes the clad (#4), and reference numeral 20 denotes the refractive index variable member. FIGS. 7A and 7B represent cross-sections vertical to the longitudinal direction of the optical fibers (#3) 13 and (#4) 14.

In FIGS. 7A and 7B, the optical fiber for irradiation (#5) 15 is arranged on the upper part of the refractive index variable member 20 on the drawing. This arrangement is an example, as long as it is sufficient that the refractive index variable member 20 can be irradiated with the light to be irradiated, and is not limited to the upper part.

FIG. 7A shows that optical coupling is generated from the core (#3) 16 to the core (#4) 17, because the optical coupling is not irradiated from the optical fiber (#5) 15. FIG. 7B shows that t the refractive index of the refractive index variable member 20 is increased and the optical coupling is not generated from the core (#3) 16 to the core (#4) 17, because the optical coupling is irradiated from the optical fiber (#5) 15. When the refractive index variable member 20 is irradiated with light, the refractive index of the refractive index variable member 20 is increased, and the confinement effect of light propagating through the core (#3) 16 is increased. Therefore, the optical coupling occurs from the core (#3) 16 to the core (#4) 17. Further, the confinement effect of the light propagating through the core (#4) 17 is increased. Therefore, the optical coupling occurs from the core (#4) 17 to the core (#3) 16.

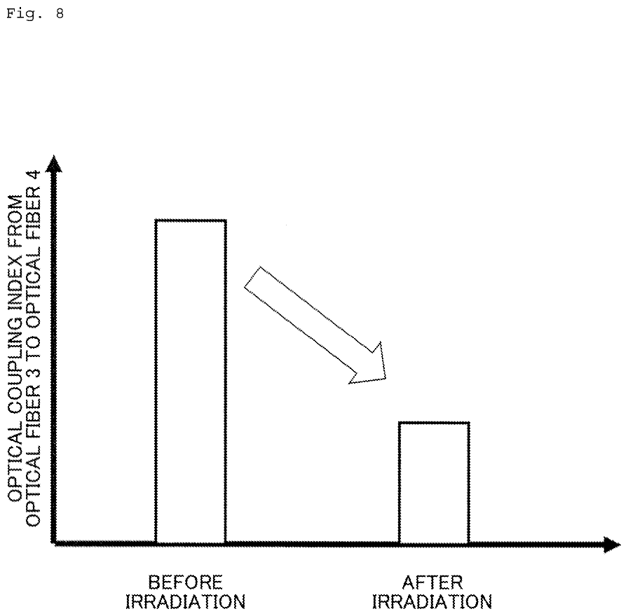

FIG. 8 shows a change in optical coupling before and after the irradiation of the refractive index variable member 20 with light. In FIG. 8, the horizontal axis represents before and after the irradiation of the refractive index variable member 20 with light, and the vertical axis represents the degree of coupling of the optical coupling from the core (#3) 16 of the optical fiber (#3) 13 to the core (#4) 17 of the optical fiber (#4) 14. When the refractive index variable member 20 is irradiated with light, it is shown that the refractive index of the refractive index variable member 20 increases to increase the confinement effect of light propagating through the core (#3) 16, and the coupling degree of optical coupling from the core (#3) 16 to the core (#4) 17 is reduced.

When the refractive index of the refractive index variable member 20 is reduced by irradiation with light, a phenomenon opposite to that shown in FIG. 8 can be realized. That is, in a state where the refractive index variable member 20 is not irradiated with light, the degree of coupling of optical coupling from the core (#3) 16 of the optical fiber (#3) 13 to the core (#4) 17 of the optical fiber (#4) 14 is set to be small, and when the refractive index variable member 20 is irradiated with light, the refractive index of the refractive index variable member 20 is reduced, the confinement effect of the light propagating through the core (#3) 16 is reduced, the coupling degree of the optical coupling from the core (#3) 16 to the core (#4) 17 can be increased.

As described above, by changing the refractive index of the refractive index variable member 20, the degree of coupling of the optical coupling between the core (#3) 16 of the optical fiber (#3) 13 and the core (#4) 17 of the optical fiber (#4) 14 can be controlled. The amount of change in the refractive index can be adjusted by using the intensity, the wavelength and the irradiation period of the light to be irradiated as parameters. When an optical fiber for irradiation for irradiating the refractive index variable member 20 with light is further provided, the refractive index variable member can be irradiated with light without providing an active component in the optical coupling device. Further, the light to be irradiated can be concentrated on the refractive index variable member 20 by the optical fiber for irradiation.

### Embodiment 2

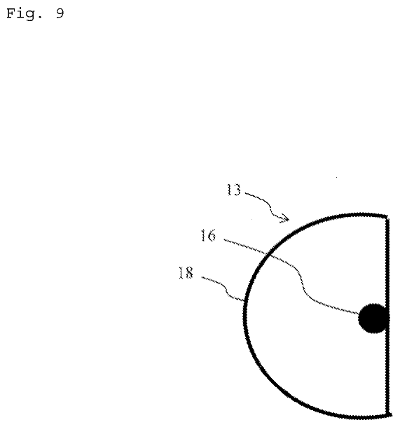

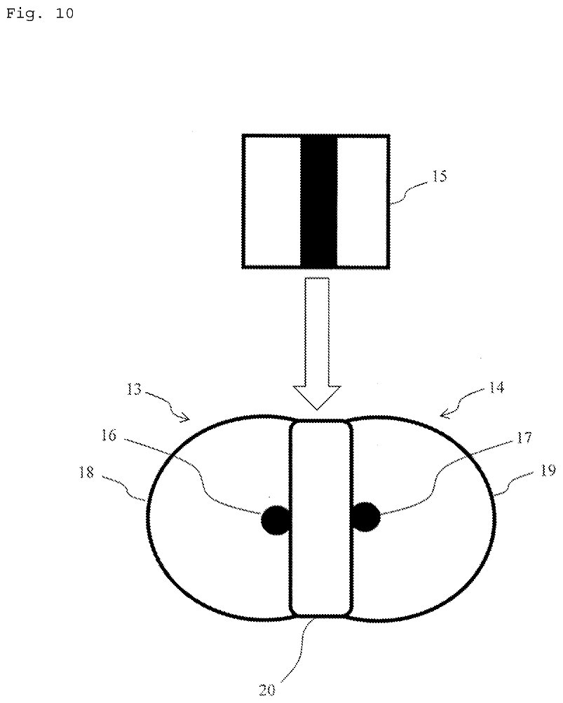

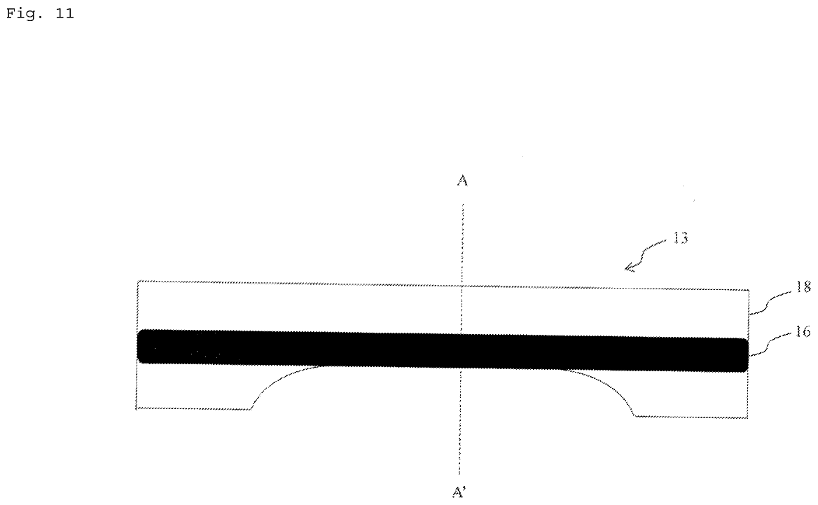

In the optical coupling device of the present disclosure, the surfaces of the clad of a portion in contact with the refractive index variable member of two optical fibers for coupling are processed into a planar shape so that the core is exposed. A specific configuration of the optical coupling device of the present disclosure will be described with reference to FIGS. 9, 10 and 11. In FIGS. 9, 10, and 11, reference numeral 13 denotes an optical fiber (#3), reference numeral 14 denotes an optical fiber (#4), reference numeral 15 denotes an optical fiber for irradiation (#5), reference numeral 16 denotes a core (#3), reference numeral 17 denotes a core (#4), reference numeral 18 denotes a clad (#3), reference numeral 19 denotes a clad (#4), and reference numeral 20 denotes a refractive index variable member. FIG. 9 shows a cross section vertical to the longitudinal direction of the optical fiber (#3) 13. FIG. 10 shows a cross-section vertical to the longitudinal direction of the optical fiber (#3) 13 and the optical fiber (#4) 14. FIG. 11 is a cross-section to the longitudinal direction of the optical fiber (#3) 13, and a cross-section vertical to the longitudinal direction at A-A′ line in FIG. 11 represents the optical fiber (#3) 13 of FIG. 9.

In FIG. 10, the optical fiber for irradiation (#5) 15 is arranged on the upper part of the refractive index variable member 20 on the drawing. This arrangement is an example, as long as it is sufficient that the refractive index variable member 20 can be irradiated with the light to be irradiated, and is not limited to the upper part.

As shown in FIGS. 9 to 11, in the optical fiber (#3) 13 for coupling used by the optical coupling device of the present disclosure, the surface of the clad (#3) 18 of the portion in contact with the refractive index variable member 20 is processed into a planar shape so that the core (#3) 16 is exposed. The same applies to the optical fiber (#4) 14 for coupling. The distance between the core (#3) 16 and the core (#4) 17 becomes closer, the optical coupling is more facilitated. As shown in FIG. 10, the cross-sectional shape of each of the optical fiber (#3) 13 and the optical fiber (#4) 14 vertical to the longitudinal direction is the D-shape, and this point is the same as that of the above embodiment. The regions processed into a planar shape of two optical fibers machined into the D-shape of the optical fiber (#3) 13 and the optical fiber (#4) 14 are arranged so as to face each other. The refractive index variable member 20 whose refractive index is changed by irradiation with light is arranged between these regions facing each other.

By processing into a D-shape, the interval between the core (#3) 16 and the core (#4) 17 is close to each other, and optical coupling is facilitated. By processing the clad (#3) 18 and the clad (#4) 19 into a planar shape so as to expose the core, optical coupling between the core (#3) 16 and the core (#4) 17 becomes denser. Further, by processing into a D-shape, the refractive index variable member 20 can be stably held between the optical fiber (#3) 13 and the optical fiber (#4) 14.

In the optical coupling device shown in FIG. 10, by irradiating the refractive index variable member 20 with light, the refractive index of the refractive index variable member 20 changes, and the optical coupling between the two optical fibers for coupling of the optical fiber (#3) 13 and the optical fiber (#4) 14 can be controlled.

In FIG. 10, the optical fiber for irradiation (#5) 15 is arranged on the upper part of the refractive index variable member 20 on the drawing. This arrangement is an example, as long as it is sufficient that the refractive index variable member 20 can be irradiated with the light to be irradiated, and is not limited to the upper part.

As described above, according to the optical coupling device of the present disclosure, since the surfaces of the clad of the portion in contact with the refractive index variable member of two optical fibers for coupling are processed into a planar shape so that the core is exposed, and optical coupling between the cores can be facilitated. Further, since the optical fiber for irradiation for irradiating the refractive index variable member 20 with light is further provided, the refractive index variable member can be irradiated with light without providing an active component in the optical coupling device. Further, the light to be irradiated can be concentrated on the refractive index variable member 20 by the optical fiber for irradiation.

### Embodiment 3

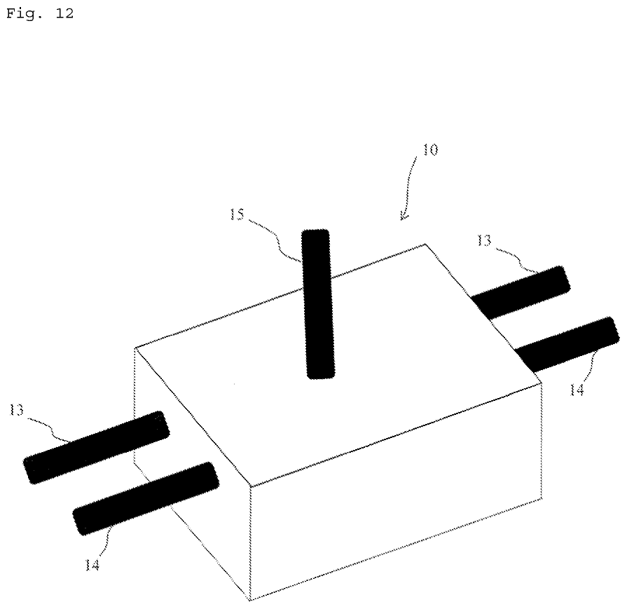

FIG. 12 shows an exterior example of the optical coupling device

of the present disclosure. In FIG. 12, reference numeral 10 denotes an optical coupling device, reference numeral 13 denotes an optical fiber (#3), reference numeral 14 denotes an optical fiber (#4), and reference numeral 15 denotes an optical fiber for irradiation (#5).

As shown in FIG. 12, it is desirable that the coupling part of the optical coupling device 10 is accommodated in a housing. This is for the protection of the coupling part. The optical fiber (#3) 13 and the optical fiber (#4) 14 are taken out from the housing. The optical fiber for irradiation (#5) is also taken out.

### Embodiment 4

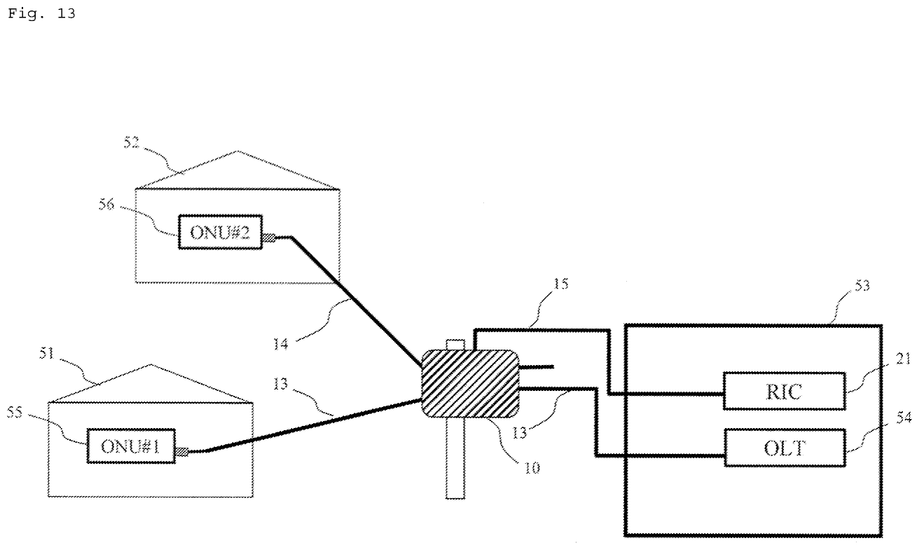

FIG. 13 shows a configuration of an optical coupling system

of the present disclosure. In FIG. 13, reference numeral 10 denotes an optical coupling device, reference numeral 13 denotes an optical fiber (#3), reference numeral 14 denotes an optical fiber (#4), reference numeral 15 denotes an optical fiber (#5), 21 denotes a refractive index control device (RIC: Refractive Index Controller), reference numeral 51 denotes a user's home (#1), reference numeral 52 denotes a user's home (#2), reference numeral 53 denotes a communication building, reference numeral 54 denotes an OLT, reference numeral 55 denotes an ONU (#1), and reference numeral 56 denotes an ONU (#2).

The OLT 54 is connected to the ONU (#1) 55 and the ONU (#2) 56 via the optical coupling device 10. The refractive index control device 21 installed in the communication building 53 transmits light to the optical coupling device 10 through the optical fiber for irradiation (#5) 15. In the optical coupling device 10, the light from the optical fiber (#5) 15 is irradiated to the refractive index variable member (not shown), and the degree of coupling of the optical coupling between the two optical fibers is controlled according to the intensity, wavelength and irradiation period of the light. In FIG. 13, the refractive index control device 21 is installed in the communication building 53, but the installation place is not limited to the inside of the communication building 53.

As described above, according to the optical coupling system of the present disclosure, the degree of coupling of the optical coupling device 10 can be controlled by transmitting or disconnecting light from the refractive index control device 21 installed in the communication building.

### Embodiment 5

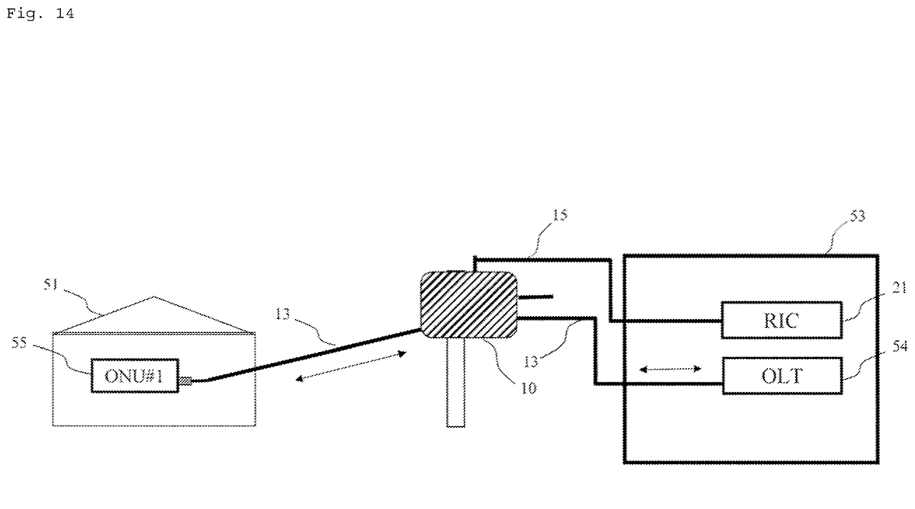

A procedure when new users desire services using an optical fiber by using an optical coupling system of the present disclosure will be described with reference to FIGS. 14, 15 and 16. In FIGS. 14, 15, and 16, reference numeral 10 denotes an optical coupling device, reference numeral 13 denotes an optical fiber (#3), reference numeral 14 denotes an optical fiber (#4), reference numeral 15 denotes an optical fiber (#5), reference numeral 21 denotes a refractive index control device (RIC: Refractive Inx Controller), reference numeral 22 denotes a portable terminal, reference numeral 51 denotes a user's home (#1), reference numeral 52 denotes a user's home (#2), reference numeral 53 denotes a communication building, reference numeral 54 denotes an OLT, 55 denotes an ONU (#1), and reference numeral 56 denotes an ONU (#2).

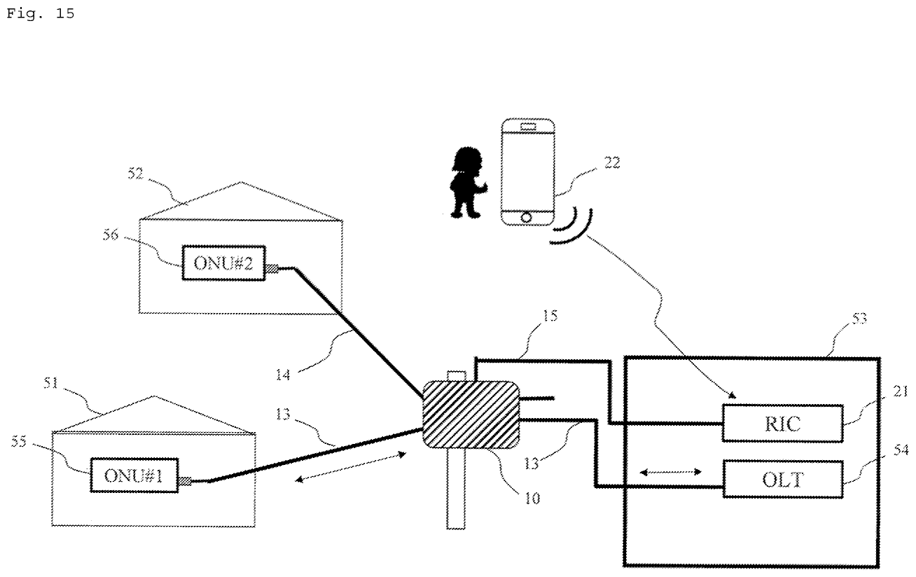

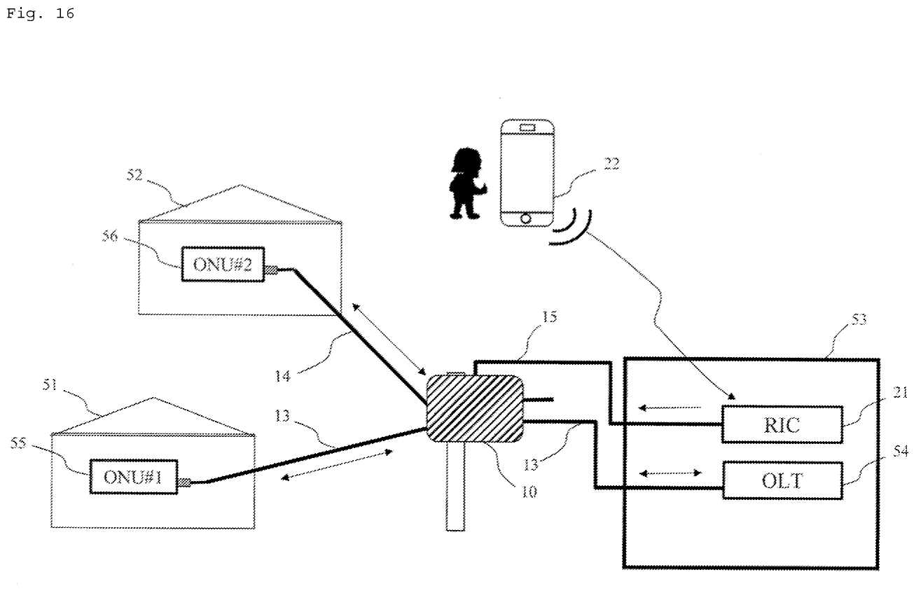

As shown in FIG. 14, an existing user connects the OLT 54 and the ONU (#1) 55 via the optical coupling device 10. When new user desire services using the optical fiber, as shown in FIG. 15, the ONU (#2) 56 is installed in the user's home (#2), the optical fiber (#4) 14 is laid between the ONU (#2) 56 and the optical coupling device 10, therefore the optical fiber (#4) 14 is connected to the ONU (#2) 56 and the optical coupling device 10. The portable terminal 22 instructs the refractive index control device 21 to irradiate or disconnect light for irradiation. As shown in FIG. 16, the refractive index control device 21 transmits or disconnects the light for irradiation to the optical coupling device 10 via the optical fiber for irradiation (#5) 15. When the refractive index variable member, not shown, is irradiated or disconnected with light for irradiation, the optical coupling device 10 optically couples two optical fibers, and communication is opened between the OLT 54 and the ONU (#2) 56.

FIGS. 15 and 16 show an example in which when light for irradiation is irradiated to the refractive index variable member (not shown), optical coupling occurs between two optical fibers in the optical coupling device 10. When disconnecting the light for irradiating to the refractive index variable member (not shown) and the optical coupling occurs between the two optical fibers, the refractive index control device 21 disconnects the light for irradiation by an instruction from the portable terminal 22.

In the case of performing the disconnecting construction of the ONU (#2) 56, the procedure shown in FIGS. 14, 15 and 16 is reversed. Also in this case, the refractive index control device 21 can disconnect the optical coupling of the optical coupling device 10.

As described above, according to the optical coupling system of the present disclosure, since the optical coupling of the optical coupling device 10 can be controlled by the refractive index control device 21 installed in the communication building 53, shortening of a period of construction and disconnecting construction, reduction of the number of workers, improvement of safety, and the like can be expected. Further, since irradiation or disconnecting with light for irradiation can be instructed from the portable terminal 22 to the refractive index control device 21, further shortening of a period of construction and disconnecting construction, reduction of the number of workers, improvement of safety, and the like can be expected.

### Embodiment 6

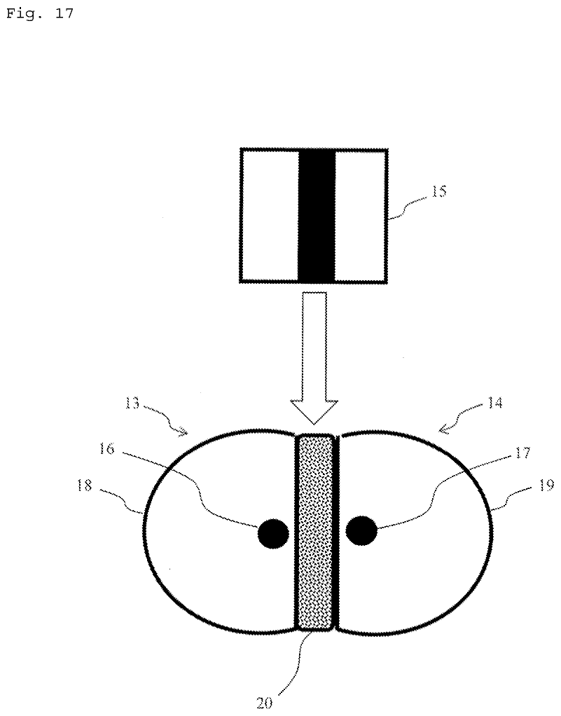

A refractive index variable member applied to an optical coupling device will be described. FIG. 17 shows the structure of the optical coupling device of the present disclosure. In FIG. 17, reference numeral 13 denotes an optical fiber (#3), reference numeral 14 denotes an optical fiber (#4), reference numeral 15 denotes an optical fiber for irradiation (#5), reference numeral 16 denotes a core (#3), reference numeral 17 denotes a core (#4), reference numeral 18 denotes a clad (#3), reference numeral 19 denotes a clad (#4), and 20 denotes a refractive index variable member. FIG. 17 shows a cross-section vertical to the longitudinal direction of the optical fiber (#3) 13.

The refractive index of the refractive index variable member 20 is varied according to the wavelength, intensity and irradiation period of the light to be irradiated in accordance with the characteristics of the material of the refractive index variable member 20. Examples of the material capable of varying the refractive index include a glass material obtained by kneading titanium oxide into glass. The titanium oxide is mixed in the form of crystalline particles in the glass into which the titanium oxide is kneaded. The crystalline particles have a size sufficient to react with light. When the refractive index variable member 20 is irradiated with light, the titanium oxide reacts with the light to change the refractive index of the refractive index variable member 20.

### INDUSTRIAL APPLICABILITY

The present disclosure is applicable to the information communication industry.

### REFERENCE SIGNS LIST

10 Optical coupling device
11 Optical fiber #1
12 Optical fiber #2
13 Optical fiber #3
14 Optical fiber #4
15 Optical fiber #5
16 Core #3
17 Core #4
18 Clad #3
19 Clad #4
20 Refractive index variable member
21 Refractive index control device
22 Portable terminal
41 Core 1
42 Core 2
43 Clad 1
44 Clad 2
51 User's home #1
52 User's home #2
53 Communication building
54 OLT
55 ONU #1
56 ONU #2
57 Optical coupler

1. An optical coupling device comprising:
two optical fibers for coupling having cores and clads; and
a refractive index variable member whose refractive index is changed by irradiation of light between the two optical fibers for coupling.

2. The optical coupling device according to claim 1, wherein
a coupling degree of optical coupling between the two optical fibers for coupling can be controlled by irradiating the refractive index variable member with the light.

3. The optical coupling device according to claim 1, wherein
the refractive index variable member is capable of varying the refractive index according to any one of an intensity, a wavelength, and an irradiation period of the light to be irradiated.

4. The optical coupling device according to claim 1, wherein
a surface of a clad of a portion of the two optical fibers for coupling in contact with the refractive index variable member is processed into a planar shape.

5. The optical coupling device according to claim 4, wherein
the surface of the clad of the portion of the two optical fibers for coupling in contact with the refractive index variable member is processed into a planar shape so that the core is exposed.

6. The optical coupling device according to claim 1 further comprising:
an optical fiber for irradiation configured to irradiate the refractive index variable member with the light.

7. An optical coupling system comprising:
the optical coupling device according to claim 6; and
a refractive index control device for irradiating the refractive index variable member with the light through the optical fiber for irradiation.

8. The optical coupling system according to claim 7 further comprising:
a portable terminal configured to instruct the refractive index control device to irradiate the refractive index variable member with light or disconnect the light.
